(19) United States
(12) Patent Application Publication
(10) Pub. No.: US 2021/0142797 A1
(43) Pub. Date: May 13, 2021

(54) ASSISTANCE DEVICE, ASSISTANCE METHOD, AND STORAGE MEDIUM

(71) Applicant: HONDA MOTOR CO., LTD., Minato-ku, Tokyo (JP)

(72) Inventors: Yuji Yasui, Wako-shi (JP); Kentaro Ishisaka, Wako-shi (JP); Nobuyuki Watanabe, Wako-shi (JP); Kovi Ahego, Wako-shi (JP); Christopher Lang, Wako-shi (JP); Liyan Liu, Tokyo (JP); Yo Ito, Tokyo (JP); Hirotaka Uchitomi, Tokyo (JP)

(21) Appl. No.: 16/621,455

(22) PCT Filed: Jun. 13, 2018
(86) PCT No.: PCT/JP2018/022552

§ 371 Date: Dec. 11, 2019

(30) Foreign Application Priority Data
Jun. 16, 2017 (JP) 2017-118700

(51) Int. Cl. G10L 15/22; G06Q 10/02; G06F 3/16; G10L 15/18; G06F 40/30; G06F 40/58

(52) U.S. Cl. CPC G10L 15/22; G06Q 10/02; G06F 3/167; G10L 2015/228; G06F 40/30; G06F 40/58; G10L 2015/223; G10L 15/1815

(57) ABSTRACT

An assistance device (100 or 500) includes an acquisitor (110 or 510) configured to acquire user-side information including input information input using voice or text by a user from a terminal device (200) of the user, an interface (160 or 540) configured to perform an operation for a work reservation, and an intermediary unit (120, 140, 520, or 560) configured to perform intention estimation of input information included in the user-side information acquired by the acquisitor, to control the interface on the basis of a result of the intention estimation, and to realize work reservation intended by the user.

### TECHNICAL FIELD

Embodiments of the present invention relate to an assistance device, an assistance method, and a program.

Priority is claimed on Japanese Patent Application No. 2017-118700, filed Jun. 16, 2017, the content of which is incorporated herein by reference.

### BACKGROUND ART

Conventionally, a translation assistance system is known, which includes a voice acquisitor that acquires the voice of a speaker speaking in a first language, a translation unit that translates a sentence indicated by the voice acquired by the voice acquisitor to a second language, a determination unit that determines whether translation accuracy in the translation unit is within a predetermined defect range, a communication unit that makes a call connection to an operator when it is determined that the translation accuracy is within the defect range, and a voice output unit that outputs the voice of an operator when the operator is called and connected and a result of translation performed by the translation unit when the operator is not connected (refer to Patent Literature 1).

### CITATION LIST

### Patent Literature

### [Patent Literature 1]

Japanese Unexamined Patent Application, First Publication No. 2017-10311

### SUMMARY OF INVENTION

### Technical Problem

However, in the conventional technology, when a user tries to reserve a facility such as an accommodation facility, in some cases, appropriate assistance may not be provided in both cases.

The present invention has been made in view of such circumstances, and an object thereof is to provide an assistance device, an assistance method, and a program which can appropriately assist with a work reservation.

### Solution to Problem

(1): According to one aspect of the present invention, an assistance device (100) includes an acquisitor (110) configured to acquire user-side information including input information input using voice or text by a user (U) from a terminal device (200) of the user, an interface (150 or 160) configured to perform an operation for a work reservation, and an intermediary unit (120 or 140) configured to perform intention estimation of input information included in the user-side information acquired by the acquisitor, to control the interface on the basis of a result of the intention estimation, and to realize a work reservation intended by the user.

Here, work includes, for example, work in which a facility is used, and work such as a road service and trouble shooting. In other words, work is a service.

(2): In the aspect of (1) described above, the interface performs the operation for a work reservation in different ways depending on the other party, and the intermediary unit returns a response that does not cause the terminal device to recognize differences in aspects of the interface by performing the same level of structuring processing on feedback from the interface.

(3): In the aspect of (1) described above, the user-side information acquired by the acquisitor includes positional information or traveling direction of the terminal device, and the assistance device further includes a refiner (124) configured to narrow down a target to be accessed by the interface on the basis of the positional information or traveling direction of the terminal device acquired by the acquisitor.

(4): In the aspect of (1) described above, the user-side information is created in a language of the user, and the intermediary unit performs an intention estimation of input information included in the user-side information on the basis of the language of the user, requests a translation unit to translate a result of the intention estimation to a language of a manager of the task, and controls the interface on the basis of a result of the translation by the translation unit.

(5): In the aspect of (1) described above, the intermediary unit causes the interface to realize communication for reservation in parallel for a plurality of pieces of work.

(6): In the aspect of (5) described above, the intermediary unit determines a task to be reserved among the plurality of pieces of work in a reverse auction method.

(7): According to another aspect of the present invention, an assistance method includes, by a computer, acquiring user-side information including input information input using voice or text by a user from a terminal device of the user, performing an intention estimation of input information included in the user-side information acquired by the acquisitor, controlling an interface that performs an operation for a work reservation on the basis of a result of the intention estimation, and realizing a work reservation intended by the user.

(8): According to still another aspect of the present invention, a program causes a computer to acquire user-side information including input information input using voice or text by a user from a terminal device of the user, perform an intention estimation of input information included in the user-side information acquired by the acquisitor, control an interface that performs an operation for a work reservation on the basis of a result of the intention estimation, and execute a work reservation intended by the user.

(9): According to still another aspect of the present invention, an assistance device includes an acquisitor configured to acquire user-side information including input information input by a user, an environment information reference unit configured to refer to environment information corresponding to the user, a task planning unit configured to plan a task based on the user-side information and the environment information, a request generator configured to generate a plurality of service requests based on the task, a service provider information reference unit configured to refer to a plurality of pieces of service provider information corresponding to the service request, and an intermediary unit configured to selectively generate an interface to a plurality of service providers corresponding to the service request.

(10): In the aspect of (9) described above, the environment information includes action history information associated with identification information of the user.

(11): In the aspect of (10) described above, the action history information includes a positional information history or a traveling direction of the user.

(12): In the aspect of (10) described above, the action history information includes web content currently being browsed or that has been browsed by the user in the past, or identification information of the web content.

(13): In the aspect of (9) described above, the intermediary unit assigns the plurality of interfaces to the service provider based on identification information of the service provider.

(14): In the aspect of (9) described above, the environment information includes voice call identification information of the user, and the plurality of interfaces include a voice call interface that executes a voice call connection based on the voice call identification information.

(15): In the aspect of (9) described above, the intermediary unit controls a plurality of voice call interfaces simultaneously and executes a voice call connection with the plurality of service provider.

(16): In the aspect of (9) described above, the intermediary unit refers to the environment information and provides a part of the environment information to the plurality of service providers via the interface.

(17): In the aspect of (16) described above, the environment information includes source information.

(18): In the aspect of (9) described above, the intermediary unit includes a log recording unit that records input and output information of the interface corresponding to the task.

(19): In the aspect of (9) described above, the task includes a main task aimed at completion of the service request, and a sub-task for achieving a milestone of the main task based on progress of the main task and a response from the service provider, and the intermediary unit dynamically acquires reference information of the task based on the main task and the sub-task, and controls an output to the user and interface.

### Advantageous Effects of Invention

According to (1) to (8), it is possible to appropriately assist with a work reservation.

According to (3), it is possible to perform an assistance such that a user who is moving (for example, in travel) can easily reserve an accommodation facility or the like ahead in the traveling direction.

According to (5) and (6), it is possible to perform an assistance such that the user can reserve a suitable work among a plurality of pieces of work.

According to (9) to (19), it is possible to select an appropriate interface.

According to (17), it is possible to consider a security by notifying information on a caller.

According to (18), it is possible to make a behavior of the assistance device transparent.

### BRIEF DESCRIPTION OF DRAWINGS

FIG. 1 is a diagram which shows an example of a usage environment of an assistance device 100 according to a first embodiment.

FIG. 2 is a functional configuration diagram of the assistance device 100 according to the first embodiment.

FIG. 3 is a diagram which shows an example of content of facility information 144.

FIG. 4 is a diagram which shows how a reservation facility is determined in a reverse auction method.

FIG. 5 is a flowchart which shows an example of a flow of processing executed in the assistance device 100.

FIG. 6 is a functional configuration diagram of an assistance device 500 according to a second embodiment.

FIG. 7 is a functional configuration diagram of the assistance device 500 according to the second embodiment.

FIG. 8 is a flowchart which shows an example of a flow of processing executed mainly in the assistance device 500 of the second embodiment.

### DESCRIPTION OF EMBODIMENTS

Hereinafter, embodiments of the assistance device, the assistance method, and the program of the present invention will be described with reference to the drawings.

### First Embodiment

FIG. 1 is a diagram which shows an example of a usage environment of an assistance device 100 according to a first embodiment. The assistance device 100 is connected to a network NW to be used. The network NW includes, for example, the Internet, a wide area network (WAN), a local area network (LAN), a wireless base station, a cellular network, a Wi-Fi network, and the like.

A terminal device 200 of a user U who intends to use a facility, a reservation service provider 300, a translation service provider 400, and the like are connected to the network NW.

The terminal device 200 is, for example, a portable terminal device such as a smartphone, a tablet terminal, or a laptop. In addition, the terminal device 200 may be an in-vehicle terminal device (Internet equipment mounted in a vehicle) or may also be a stationary desktop computer or the like when the user U is in a vehicle. The vehicle which the user U is in may be an autonomous driving vehicle, and in this case, a position of a facility that is reserved as will be described below may be automatically set as a destination for automatic driving.

The terminal device 200 receives a voice input or a test input of the user by starting an application program and the like, and transmits the received information to the assistance device 100. In addition, the terminal device 200 includes a position acquisitor that uses a position of a global navigation satellite system (GNSS) or a wireless base station, and the like, and transmits a position of the terminal device 200 or a traveling direction of the terminal device 200 (a traveling direction of the user U) based on a change in the position to the assistance device 100 on a regular basis.

The reservation service provider 300 is accessed by a terminal device (hereinafter, a facility terminal) B-1 of a facility B that is reserved through the Internet, and realizes a network reservation of the facility B on the basis of an instruction from the assistance device 100. In addition, the reservation service provider 300 may receive a network reservation in a general sense, that is, a reservation, by accessing a website of the reservation service provider 300 via the Internet.

The translation service provider 400 undertakes translation between desired languages on the basis of a request from the assistance device 100.

Note that, in FIG. 1, for a facility A that only receives reservations over the phone, the assistance device 100 makes a reservation automatic according to an utterance using artificial intelligence or by instructing a telephone operator.

FIG. 2 is a functional configuration diagram of the assistance device 100 according to the first embodiment. The assistance device 100 includes, for example, an acquisitor 110, a front-end intermediary unit 120, a back-end intermediary unit 140, a voice processing unit 150, and a service interface 160. In addition, the assistance device 100 causes a storage device such as a random access memory (RAM), a flash memory, or a hard disk drive (HDD) to store service request information 130 and facility information 144.

The acquisitor 110 includes, for example, a network interface card (NIC). The acquisitor 110 acquires user-side information including input information input by a voice or text of the user U from the terminal device 200. The user-side information may include positional information or traveling direction information of the terminal device 200.

The front-end intermediary unit 120 includes, for example, a response unit 122, a target area refiner 124, and a task scheduler 126. These functional units are realized by a processor such as a central processing unit (CPU) executing a program (software). In addition, some or all of these functional units may be realized by hardware such as a graphics processing unit (GPU), a large scale integration (LSI), an application specific integrated circuit (ASIC), and a field-programmable gate array (FPGA), or may also be realized by software and hardware in cooperation.

The response unit 122 receives a reservation for a facility or guides the user to the reservation of a facility in a form of a conversation with the user U of the terminal device 200. At this time, the response unit 122 estimates an intention of the user U on the basis of the input information. For example, the response unit 122 estimates the intention of the user U by converting input information described in plain text to structured data according to artificial intelligence (AI) and machine learning such as deep learning. The intention of the user U is, for example, abstracted data that can be recognized by a computer, such as “date: ∘ month ∘ day, place: sightseeing spot xx, number of nights: 1 night, meal: Japanese food.” In addition, the response unit 122 refers to content of the service request information 130, generates content of a conversation in accordance with a progress status of the reservation of a facility, and transmits the generated content to the terminal device 200.

The target area refiner 124 narrows down an area in which a facility accessed (inquiring about reservation) by an interface (the voice processing unit 150 or the service interface 160) exists (target area) on the basis of the positional information or traveling direction of the terminal device 200 acquired by the acquisitor 110. For example, the target area refiner 124 narrows the area too an area which is ahead of the terminal device 200 (user U) in the traveling direction, and which is estimated to be reachable by sunset by a moving means based on a traveling speed. Such processing corresponds to, for example, the fact that the user U is moving in a vehicle without having decided on an accommodation place, and intends to decide on a facility in which to stay after enjoying a trip in the vehicle without interruption.

The task scheduler 126 generates the service request information 130 on the basis of a result of the estimation by the response unit 122 and a result of the narrowing by the target area refiner 124. The service request information 130 is information that is labeled according to a service request number (No) and includes a target range and a negotiation status. The target range is information including, for example, “date and time,” “target area,” “facility type,” “charge range,” and the like. The negotiation status is information indicating to which stage a response from a facility has advanced with respect to an operation performed by processing of the back-end intermediary unit 140.

The back-end intermediary unit 140 includes, for example, a facility communication processing unit 142 and a translation request unit 146. The facility communication processing unit 142 refers to the facility information 144, and identifies a facility to be accessed for each service request No included in the service request information.

FIG. 3 is a diagram which shows an example of content of the facility information 144. As shown in FIG. 3, the facility information 144 is obtained by associating information such as a position of a facility, attributes of the facility, and a reservation means with a facility ID that is identification information of the facility. The facility communication processing unit 142 extracts facilities that match a target range of the service request information 130 (hereinafter referred to as candidate facilities), and causes the voice processing unit 150 or the service interface 160 to perform an operation for negotiating a reservation using a means corresponding to the reservation means.

If the reservation means for a candidate facility is a telephone, the facility communication processing unit 142 controls the voice processing unit 150 and a telephone 152 and causes them to make a call to a facility reservation number using a synthesized voice. The facility communication processing unit 142 has the same function as the response unit 122, recognizes utterance content of the other party to convert it to structured data, and causes the voice processing unit 150 to generate utterance content for conveying reservation request content to the telephone 152. Note that, instead of this, the facility communication processing unit 142 may have a telephone operator perform a conversation by conveying content of the conversation to the telephone operator.

In addition, if the reservation means for a candidate facility is the Internet, the facility communication processing unit 142 controls the service interface 160 and causes it to perform processing of inputting a predetermined form to the Internet site provided by the reservation service provider 300. This predetermined form is not limited to a form for making a reservation immediately, but may be a form for making an inquiry by text.

In this manner, the assistance device 100 has a plurality of interfaces to a facility side, and realizes a conversation with the user U in a form in which the user U is not made aware of these differences.

In addition, when there are a plurality of candidate facilities, the facility communication processing unit 142 may perform communication for the plurality of candidate facilities in parallel, and determine a facility (reservation facility) to be reserved in a reverse auction method (a bid method). FIG. 4 is a diagram which shows how a reservation facility is determined in the reverse auction method. As shown in FIG. 4, when responses such as “available at a rate of 10,000 yen” from a facility A, “not available” from a facility B, “available at a rate of 9,500 yen” from a facility C, and “available at a rate of 8,500 yen” from a facility D are made as a result of inquiring whether a facility can be used under a predetermined condition, the facility D may be determined as a reservation facility.

In addition, when processing until the service request information 130 is generated is performed in a language (a language of a user) different from a language used in a facility, the facility communication processing unit 142 may cause the translation request unit 146 to request that the translation service provider 400 provide translation. Note that such processing may be performed in the front-end intermediary unit 120. In this case, the input information acquired by the acquisitor 110 may be translated to the language used in a facility, or the processing until the service request information 130 is generated may be performed in another language and the service request information 130 may be generated in the language used in a facility.

Hereinafter, a flow of processing executed in the assistance device 100 will be described. FIG. 5 is a flowchart which shows an example of the flow of processing executed in the assistance device 100. The processing of this flowchart is started, for example, when new user-side information is acquired by the acquisitor 110.

First, the response unit 122 performs an intention estimation on the basis of the input information (step S100). The target area refiner 124 narrows down a target area on the basis of the position or the traveling direction (step S102). Next, the response unit 122 determines whether an intention of the user U to use a facility has been estimated (step S104). When the intention of the user U to use a facility has not been estimated, the processing returns to step S100.

When the intention of the user U to use a facility has been estimated, the task scheduler 126 newly generates the service request information 130 (step S106), and sets the negotiation status to “in negotiation” (step S108).

Subsequent processing may be performed by sequentially referring to the service request information 130 asynchronously with steps S100 to S108. The facility communication processing unit 142 extracts a candidate facility from the facility information 144 (step S110), and instructs the voice processing unit 150 and/or the service interface 160 to perform an inquiry to the candidate facility (step S112).

Next, the facility communication processing unit 142 determines whether there is a question from the facility side (step S114). When there is a question from the facility side, the facility communication processing unit 142 changes a negotiation status of the service request information 130 to “question” (step S116). At this time, information indicating content of the question is recorded in the service request information 130. In response to this, the response unit 122 transmits inquiry information indicating the content of the question to the terminal device 200 (step S118).

When it is determined in step S114 that there is no question from the facility side (this includes cases in which there are no questions left as a result of responding to several questions), the facility communication processing unit 142 determines whether there are available facilities (step S120).

When it is determined that there are available facilities, the facility communication processing unit 142 selects a facility with the best conditions among the available facilities (step S122). The conditions may include not only usage charges but also conditions such as facility attributes and quality. The response unit 122 may interpret conditions included in the input information from the terminal device 200 (not only conditions that are directly designated, but also conditions that are suggested in a conversation). Next, the facility communication processing unit 142 changes the negotiation status of the service request information 130 to “available” (step S124). At this time, various types of information on a facility are recorded in the service request information 130. On the other hand, when it is determined that there are no available facilities, the facility communication processing unit 142 changes the negotiation status of the service request information 130 to “not available” (step S128).

Then, the response unit 122 notifies the terminal device 200 of availability of a facility (step S126). When a facility can be used, the response unit 122 transmits all of various types of information on the facility to the terminal device 200.

According to the assistance device 100 of the first embodiment described above, the assistance device 100 includes the acquisitor 110 that acquires user-side information including input information input using voice or text by a user U from the terminal device 200 of the user U with work, the interface (150 or 160) that performs an operation for a work reservation, and the intermediary unit (120 or 140) that performs an intention estimation of input information included in the user-side information acquired by the acquisitor 110, controls the interface on the basis of a result of the intention estimation, and realizes a work reservation as intended by a user, and thereby it is possible to appropriately assist with the work reservation.

For example, in conventional technology, in an accommodation facility that could only receive a reservation over the phone, when a foreigner wanted to reserve an accommodation facility that is managed (run) by an elderly person and the like, it was necessary to make a reservation by making a request for interpretation. In this regard, by using the assistance device 100 of the embodiment, it is possible to reserve a facility regardless of language.

In addition, in a society in which automation and intelligence have advanced, it is expected that a contractor who has confirmed a reservation quickly with a small amount of information can successfully take an order for a service. In this regard, in the assistance device 100 of the embodiment, it is possible to establish a reservation quickly by using the facility information 144 collected in advance.

Note that collection of the facility information 144 may be performed, for example, at a business in which a local government undertakes introduction and receives a referral fee and a brokerage fee. In addition, a mechanism in which an operator of the assistance device 100 receives an incentive from the reservation service provider 300 or the translation service provider 400 according to the establishment of a reservation may be constructed.

### Second Embodiment

Hereinafter, an assistance device 500 of a second embodiment will be described. For a usage environment of the assistance device 500, FIG. 1 is used and a description thereof will be omitted.

FIGS. 6 and 7 are functional configuration diagrams of the assistance device 500 according to the second embodiment. As shown in FIG. 6, the assistance device 500 includes, for example, an acquisitor 510, a front-end intermediary unit 520, an input and output interface (I/F) 540, and a reference unit 550. Each of the front-end intermediary unit 520 and a back-end intermediary unit 560 to be described below are realized by, for example, a processor such as a CPU executing a program (software). In addition, some or all of respective units may be realized by hardware such as a GPU, an LSI, an ASIC, or an FPGA, or may be realized by cooperation of software and hardware.

The acquisitor 510 acquires, for example, user-side information including input information input in the form of voice, text, and the like by the user U from the terminal device 200 via the input and output I/F 540. The user-side information may include the positional information or traveling direction information of the terminal device 200.

The front-end intermediary unit 520 includes, for example, a basic input/output (I/O) module 522, an intention and instruction estimator 524, and a task scheduler 530.

The basic I/O module 522 includes a voice/text conversion unit, a display device control unit, and the like. The basic I/O module 522, like the response unit 122 of the first embodiment, for example, performs processing for receiving a facility reservation or inducing the facility reservation in a form of a conversation with the user U of the terminal device 200. When the input information is voice, the basic I/O module 522 converts this into text and outputs it to the intention and instruction estimator 524. In addition, when the input information is text, the basic I/O module 522 outputs this text to the intention and instruction estimator 524 as it is. Moreover, the basic I/O module 522 refers to content of the service request information 536, generates content of the conversation in accordance with a progress status of the task, and transmits it to the terminal device 200.

The intention and instruction estimator 524 estimates content of an intention or an instruction of the user U on the basis of the input text. For example, the intention and instruction estimator 524 estimates details of the intention or instruction of the user U by converting the input information described in plain text into structured data according to artificial intelligence (AI) and machine learning such as deep learning. The intention and instruction estimator 524 determines a main task (for example, a “reservation of an accommodation facility”) in accordance with the estimated content.

The task scheduler 530 includes a task domain and main task determination unit 532, and a request generator 534.

The task domain and main task determination unit 532 generates a request generator 534 (domain control module) in accordance with a domain (classification attribute) of the main task determined by the intention and instruction estimator 524. At this time, the task domain and main task determination unit 532 generates the request generator 534 on the basis of environment information of a user referred to by the environment information reference unit 554 of the reference unit 550, task domain information referred to by the task domain information reference unit 556, and a task priority referred to by the task priority reference unit 558.

The environment information includes, for example, information such as various types of action history information such as phone number, CID that is caller information, gender, age, request for non-smoking or smoking, web browse history (a current or past history), and terminal operation history. The action history information may include a history of the positional information or a history of the traveling direction of a user. The task domain and main task determination unit 532 generates the request generator 534 so as to match the environment information.

The task domain information includes, for example, a task ID that is the identification information of a task, a task domain ID that is the identification information of a task domain, an execution and end condition, a format of an available interface, a range of reference information, and the like.

For example, when the environment information indicates that the user is moving a long distance from home, and refers to or intends to reserve a facility, the task domain and main task determination unit 532 assigns a main task (a reference and reservation of an accommodation facility as an example) with a current place and progress information set as initial conditions in a task domain referred to as “facility information reference and reservation.” In addition, when the user tries a report in a task domain referred to as “traffic accident handling,” the task domain and main task determination unit 532 may assign a main task of contacting all contact targets such as police agencies, family members, and insurance companies based on the environment information such as information on VIN and the like of a vehicle used by the user and driver information.

The task priority is, for example, information in which a priority, an alternative task ID, an execution and end condition of an alternative task, and the like are associated with a task ID.

The request generator 534 determines an execution order of the sub-tasks corresponding to a completion of the main task. The sub-task is for achieving a milestone of the main task based on progress of the main task and a response from the service provider. For example, when the main task is a telephone reservation, the execution order of the sub-tasks is determined in an order of an identification of a service provider, an identification of a phone number, an identification of a language, an activation of the translation UF, and a call. In addition, the request generator 534 generates the service request information 536. Here, each task may be executed by combining modules belonging to different domains. For example, the status of a part of the task may be notified in the middle, or, when a result of the execution is feedback to a user or there is a specific request from the service provider side in the conversation, processing corresponding to this may be executed. For example, as confirmation of additional information, confirmation of smoking or non-smoking may be handled by a reference control module of the environment information, and may also be switched to a call via a translation module when languages are different.

The service request information 536 is information that is labeled according to a service request number (No) and includes a target range and a negotiation status. The target range is information including, for example, “date and time,” “target area,” “facility type,” “charge range,” and the like. The negotiation status is information indicating to which stage a response from a facility has advanced with respect to an operation performed by processing of the back-end intermediary unit 560.

The back-end intermediary unit 560 includes, for example, a log recording unit 570, an external module calling unit 580, and an input and output controller 590.

The log recording unit 570 records input and output information of the input and output I/F 540 corresponding to a task. The input and output information is voice or text. The log recording unit 570 holds this voice and text using a storage device for a certain period of time.

The external module calling unit 580 calls an external module such as a translation module.

The input and output controller 590 dynamically acquires reference information of a task based on a main task and a sub-task, and controls an output to a user and an interface. The input and output controller 590 selectively generates an input and output I/F 540 to a plurality of service providers corresponding to a service request. At this time, the input and output controller 590 selects the input and output I/F 540 (assigns it to a service provider) on the basis of service provider information referred to by a service provider information reference unit 552. The input and output I/F 540 includes a voice call interface that executes a voice call connection based on a CID of a user.

The service provider information includes, for example, identification information of a service provider, a language used by a service provider, a format of an available interface, facility positional information, service attributes, and the like.

The input and output controller 590 may select the input and output I/F 540 that provides a part of the environment information of the user described above and attribute information structured by being converted by the intention and support estimation unit 524 to a management server of the service provider such that the management server can read them, or select the input and output I/F 540 that presents input information such as voice, images, and options from the service provider to the terminal device of the user by converting it directly or in a method set in advance. In addition, there may be a plurality of the input and output I/Fs 540 selected herein, and they may be combined in parallel or in series. For example, language-specific interfaces for English and Japanese may be provided to the service provider, and translation (conversion) interfaces are set in series for a voice input, and thereby an output can be converted into voice based on a result of the translation. Here, the input and output I/F 540 is configured by an interface that reads and writes information shared on the storage device at an arbitrary timing by granting an access thereto in one direction or bi-directions, input and output pairs converted based on a rule set in advance, and the like. The input and output controller 590 receives an operation input specialized for the main task or the sub-task to be executed by this input and output I/F 540 and processes reception signals from the bi-directions, thereby executing processing associated with a task. In other words, in this input and output I/F 540 defined and assigned, information to be shared, information to be transmitted from one side to the other side, and each type of processing that can be called and executed are specified.

The input and output controller 590 identifies a service provider on the basis of service provider information, and further identifies a phone number and a language of the service provider, a usage condition of the translation module, an input and output I/F, and the like to perform processing such as an input of usage environment information and determination of call content.

FIG. 8 is a flowchart which shows an example of a flow of processing executed mainly in the assistance device 500 of the second embodiment.

First, voice is input to the front-end intermediary unit 520 (an FE intermediary unit in FIG. 8) from a user interface of a user (a user UI in FIG. 8) (step S200).

A basic I/O module 522 of the front-end intermediary unit 520 performs a language analysis and converts the voice into text (step S202). Next, the intention and instruction estimator 524 and the task domain and main task determination unit 532 estimates an intention of the user by referring to the user-side information and the environment information, and determines a main task (step S204). Subsequently, the ask domain and main task determination unit 532 determines a task domain (step S206), and generates a task execution corresponding module (the request generator 534) (step S208).

The request generator 534 generates a service request and generates a corresponding sub-task (step S210). The front-end intermediary unit 520 updates the status and is in a state of receiving an additional operation (step S212). If voice input is further made in this state (step S200), subsequent processing after step S202 is executed again.

The input and output controller 590 of the back-end intermediary unit 560 determines a corresponding domain, determines a corresponding I/F (the input and output I/F 540 to be used), and executes a corresponding module (step S214). As a result, the input and output OF 540 executes a voice call (steps S216 and S218). Note that, when there are a plurality of call destination service providers, the input and output controller 590 may simultaneously control a plurality of input and output I/Fs 540 (voice call interfaces), and execute a voice call connection with a plurality of service provider. In addition, when translation is required, the external module calling unit 580 calls the translation module and causes it to perform translation.

At this time, the input and output controller 590 may provide a part of the environment information of a user to a call destination service provider via the input and output I/F 540 (other than the voice call interface). The provided environment information may be limited within a range permitted by the user.

If a voice call ends, the input and output controller 590 notifies a completion of execution of a sub-task corresponding module (step S220). In response to this, the front-end intermediary unit 520 performs a determination that a sub-task ends (step S222), performs a determination that a main task ends (step S224), and generates a response by determining an end status (step S226). A user UI receives the response (step S228).

According to the second embodiment described above, in addition to the same effects as the first embodiment, it is possible to automatically select an appropriate interface.

As described above, modes for implementing the present invention have been described using the embodiments, but the present invention is not limited to these embodiments, and various modifications and substitutions can be made without departing from the gist of the present invention.

What is claim is:

1. An assistance device comprising:
an acquisitor configured to acquire user-side information including input information input using voice or text by a user from a terminal device of the user;
a plurality of interfaces configured to perform an operation for a work reservation; and
an intermediary unit configured to perform intention estimation of input information included in the user-side information acquired by the acquisitor, to generate the plurality of interfaces selectively and control the plurality of generated interfaces in parallel on the basis of a result of the intention estimation, to autonomously perform communication for a work reservation intended by the user, and to provide a response regarding whether a work reservation is possible in the plurality of interfaces to the terminal device of the user.

2. The assistance device according to claim 1,
wherein the interface performs the operation for a work reservation in different ways depending on the other party, and
the intermediary unit returns a response that does not cause the terminal device to recognize differences in aspects of the interface by performing the same level of structuring processing on feedback from the interface.

3. The assistance device according to claim 1,
wherein the user-side information acquired by the acquisitor includes positional information or traveling direction of the terminal device, and
the assistance device further comprising a refiner configured to narrow down a target to be accessed by the interface on the basis of the positional information or traveling direction of the terminal device acquired by the acquisitor.

4. The assistance device according to claim 1,
wherein the user-side information is created in a language of the user, and
the intermediary unit performs an intention estimation of input information included in the user-side information on the basis of the language of the user, requests a translation unit to translate a result of the intention estimation in a language of a manager of the work, and controls the interface on the basis of a result of the translation by the translation unit.

5. (canceled)

6. The assistance device according to claim 1,
wherein the intermediary unit determines a piece of work to be reserved among the plurality of pieces of work in a reverse auction method.

7. An assistance method comprising:
by a computer,
acquiring user-side information including input information input using voice or text by a user from a terminal device of the user;
performing an intention estimation of input information included in the acquired user-side information;
controlling an interface that performs an operation for a work reservation on the basis of a result of the intention estimation; and
realizing a work reservation intended by the user.

8. A computer readable non-transitory storage medium storing a program which causes a computer to
acquire user-side information including input information input using voice or text by a user from a terminal device of the user;
perform an intention estimation of input information included in the acquired user-side information;
control an interface that performs an operation for a work reservation on the basis of a result of the intention estimation; and
execute a work reservation intended by the user.

9. An assistance device comprising:
an acquisitor configured to acquire user-side information including input information input by a user;
an environment information reference unit configured to refer to environment information corresponding to the user;
a task planning unit configured to plan a task based on the user-side information and the environment information;
a request generator configured to generate a plurality of service requests based on the task;
a service provider information reference unit configured to refer to a plurality of pieces of service provider information corresponding to the service request; and
an intermediary unit configured to selectively generate an interface to a plurality of service providers, to control the plurality of generated interfaces simultaneously, and to control an output to a terminal of the user based on a response from the plurality of service providers corresponding to the service request.

10. The assistance device according to claim 9,
wherein the environment information includes action history information associated with identification information of the user.

11. The assistance device according to claim 10,
wherein the action history information includes a positional information history or a traveling direction of the user.

12. The assistance device according to claim 10,
wherein the action history information includes web content currently being browsed or has been browsed by the user in the past, or identification information of the web content.

13. The assistance device according to claim 9,
wherein the intermediary unit assigns the plurality of interfaces to the service provider based on identification information of the service provider.

14. The assistance device according to claim 9,
wherein the environment information includes voice call identification information of the user, and
the plurality of interfaces include a voice call interface that executes a voice call connection based on the voice call identification information.

15. The assistance device according to claim 9,
wherein the intermediary unit controls a plurality of voice call interfaces simultaneously and executes a voice call connection with the plurality of service providers.

16. The assistance device according to claim 9,
wherein the intermediary unit refers to the environment information and provides a part of the environment information to the plurality of service providers via the interface.

17. The assistance device according to claim 16,
wherein the environment information includes source information.

18. The assistance device according to claim 9,
wherein the intermediary unit includes a log recording unit that records input and output information of the interface corresponding to the task.

19. The assistance device according to claim 9,
wherein the task includes a main task aiming at completion of the service request, and
a plurality of sub-tasks for achieving a milestone of the main task based on a progress of the main task and a plurality of responses from each of the plurality of service providers, and
the intermediary unit dynamically acquires reference information of the task based on the progress of the main task and the plurality of sub-tasks, controls an output to the user and interface, and provides the terminal device of the user with a result of whether the milestone of the main task is achieved.

20. An assistance method comprising:
by a computer,
acquiring user-side information including input information input by a user;
referring to environment information corresponding to the user;
planning a task based on the user-side information and the environment information;
generating a plurality of service requests based on the task;
referring to a plurality of pieces of service provider information corresponding to the service request; and
generating an interface to a plurality of service providers selectively corresponding to the service request.

21. A computer readable non-transitory storage medium storing a program which causes a computer to
acquire user-side information including input information input by a user;
refer to environment information corresponding to the user;
plan a task based on the user-side information and the environment information;
generate a plurality of service requests based on the task;
refer to a plurality of pieces of service provider information corresponding to the service request; and
generate an interface to a plurality of service providers selectively corresponding to the service request.
